(19) United States
(12) Patent Application Publication
(10) Pub. No.: US 2009/0058316 A1
(43) Pub. Date: Mar. 5, 2009

(54) Magnetic ballast

(76) Inventors: Tell Fausto Ferrao, Sao Paulo (BR); Benito Alvaro Sabaris, Buenos Aires (AR)

Correspondence Address: BACON & THOMAS, PLLC, 625 SLATERS LANE, FOURTH FLOOR, ALEXANDRIA, VA, 22314-1176, US

(21) Appl. No.: 11/918,991

(22) PCT Filed: Apr. 20, 2006
(86) PCT No.: PCT/BR2006/000074

§ 371 Date: Apr. 30, 2008

(30) Foreign Application Priority Data
Apr. 22, 2005 (AR) M20050101604
Dec. 8, 2005 (BR) MU8502725-1

(51) Int. Cl. H05B 41/16

(52) U.S. Cl. 315/291

(57) ABSTRACT

Magnetic ballast comprising a covered fairing, case or base with cover, basically rectangular, without limitation to the effects of the present patent, constituted by a ballast or a magnetic reactance (B), a compensating capacitor (C), and both ballast and compensating capacitor are put inside a covered fairing, case or base, forming the same piece, of suitable metallic or plastic material as epoxy resin, polyester or the like. It is important to point out that such material or shape to be used on fairing or case is non-limiting.

### FIELD OF THE INVENTION

This patent of a Utility Model relates to improvements introduced in magnetic ballast, more specifically used as an element of switching on and working of lamps or fluorescent tubes.

### FUNDAMENTALS OF INVENTION

It is known in the art, in using of lighting circuits with lamps or fluorescent tubes, the use of magnetic ballast or reactance, starters, supports, light or roof light, switches, connection cables and optionally compensation capacitor.

These components interconnect to produce a proper working for the lamp or fluorescent tube.

This kind of lighting circuit presents to main source a reactive type charge, and, thus, factor of circuit power is different of 1.

Utility companies demand a minimum value for power factor of 0.85 and in the case such value is not achieved, consumer will be afflicted. In order to correct such inconvenience it is used a capacitor which unique function is to compensate the value of power factor to higher values to that mentioned above.

According the current state of art, there is no such a magnetic ballast or magnetic reactance in the market that may be presented to the public under the same fairing or case with a compensation capacitor. Such situation leads the technician to renounce to the idea of including such compensation capacitor upon the electric circuit original installation in order to reduce costs in its installation and maintenance. Such missing device will cause later inconvenience to user.

In order to exemplify a lighting circuit with fluorescent lamps without the installation of said capacitor, FIG. 1 shows a typical electric diagram when such device was not included.

### BRIEF DESCRIPTION OF THE INVENTION

Considering the foregoing and by the present device, applicant presents the improvement introduced in magnetic ballast in order that upon fairing or case containing the ballast, a capacitor linked to it will also be included, preventing the detected and not yet solved problem in one piece.

The device with compensated ballast comprising rectangular basically fairing, without limitation, formed by a base and cover provided with the magnetic ballast and the compensating capacitor. Those two components, the magnetic ballast and the capacitor are both serial linked electrically.

The compensated magnetic ballast will have available, by means of binding points, cables and other connection mechanism, without limitation, three electrical connections that shall be interconnected properly with remaining elements necessary for the implementation of a lighting circuit with compensated fluorescent lamps or tubes, as it is shown in FIG. 2.

With this arrange and under the new improvement, there is no need for internal binding points, which would be necessary to connect capacitor, ballast and the fluorescent tube, as well as further cables and manpower.

One of the connections corresponds to linking between ballast and capacitor, which should be connected to a circuit breaker end; on the other hand, the other breaker end is connected to a terminal known as hot conductor or L line from power supply. One other connection is related to the other ballast end, which should be connected to one of the lamp filaments or fluorescent tube.

The third connection refers to other capacitor end and should be connected to the power supply terminal or neutral conductor and to other lamp filaments. Finally, it is connected to starter between the remaining lamp filaments.

Power supply may be required by lamp or fluorescent tube and/or lamp assigned to the circuit type.

### DESCRIPTION OF THE DRAWINGS

To complement the present description in order to a better understanding of the present invention features and pursuant to a practical preferred execution of it, there is enclosed to description a drawing set, which for illustrative and not limiting purposes, represent as follows:

FIG. 1 is a technical scheme of lighting circuit with fluorescent lamps without compensation;

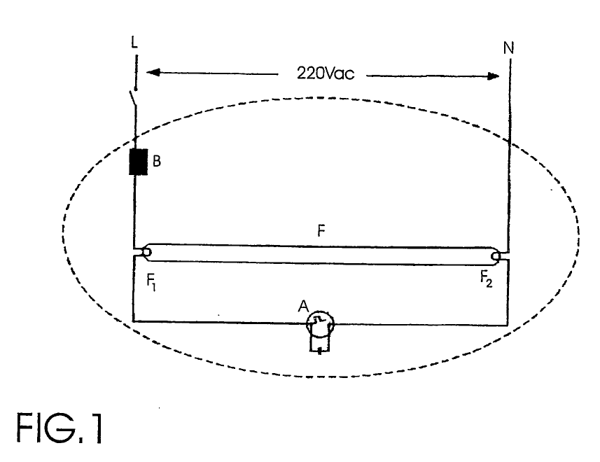

FIG. 2 is a technical scheme of lighting circuit with fluorescent lamps with compensation;

FIG. 3 is a non-limiting exhibition by means of parts of the new device; and

FIG. 4 shown merely as an illustration, without any limitation or acceptance for final fairing—shows finished product, inside of which the magnetic ballast and capacitor are included in different ways, which could be the user preferred arrangements.

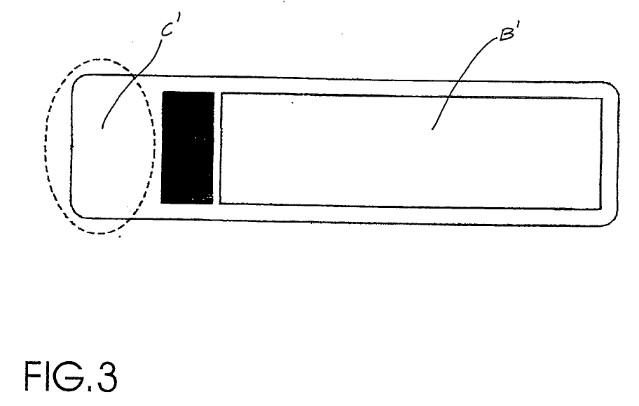

It is important to emphasize that in FIG. 3, indication C′ represents connections and B′ represents the magnetic ballast hereunder.

### DETAILED DESCRIPTION OF THE INVENTION

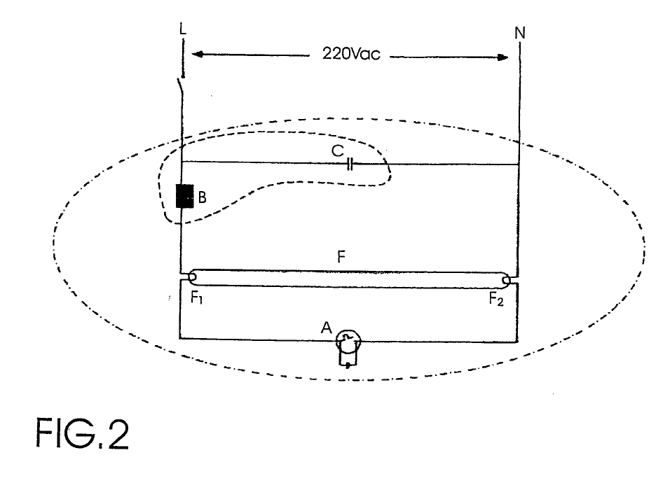

Referring to technical scheme shown in FIG. 2, the present invention corresponds to an “IMPROVEMENT INTRODUCED ON MAGNETIC BALLAST”, of type used in switching circuits and feeding of lamps, fluorescent tubes or the like. This compensated magnetic ballast comprising electric and electronic means connected physically to lamps or fluorescent tubes.

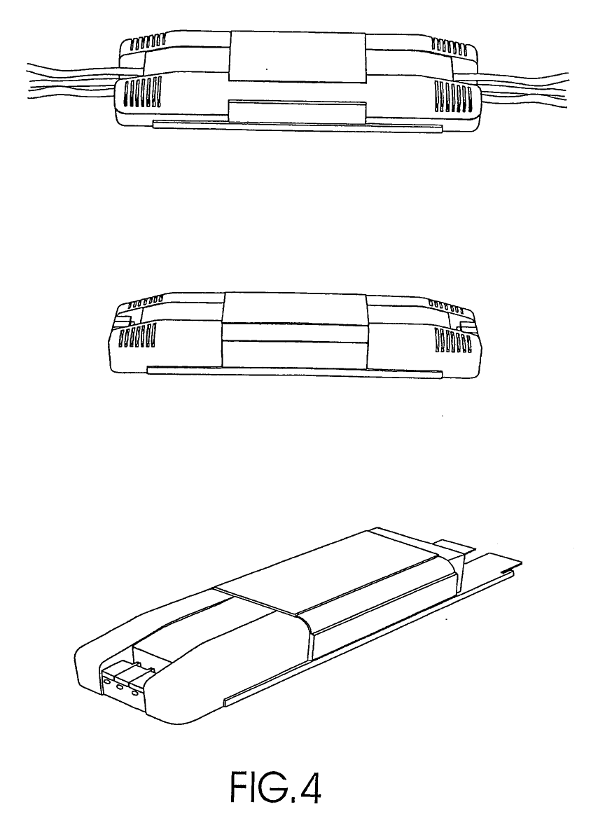

In accordance with the present invention, the compensated magnetic ballast device comprises a fairing rectangular basically, without representing any limitation for the effects of the present patent, constituting by a ballast or a magnetic reactance B, a compensating capacitor C, and both ballast and compensating capacitor are put inside the same fairing or metallic or plastic case suitable, as epoxy resin, polyester or similar. It is important to point out that such material or shape to be used on fairing or case is not a limitation. As an illustration and not being a limitation or acceptance of the final model, FIG. 4 presents different shapes, which the finished product could take in its final presentation to user.

That device, which has inside it the compensated ballast B and the compensating capacitor C, is connected externally in parallel to the lamp or fluorescent tube F, which by its turn is fitted with a connected parallel starter A, also externally to the device which is the subject of the present patent.

In spite of being detailed, it is important to understand that the application of such invention is not limited to details and steps described herein. Invention is able to other modalities and to be carried out or executed in a variety of ways. It should be understood that the terminology, figures and drawings hereunder are for descriptive purposes and are non-limiting.

1. “MAGNETIC BALLAST” of type used in switching on and power supply circuits for lamps or fluorescent tubes or the like; said compensated magnetic ballast comprising electric and electronic means connected to lighting means and wherein by the fact that comprising under the same fairing, a case or base fitted with a cover, a ballast or magnetic reactance and a compensating capacitor connected electrically in series, the compensated ballast shall have available, through binding points, cables and other connecting mechanism, without limitation, three electrical connections that shall be interconnected correctly to the remaining elements necessary to the implementation of the lighting circuit with lamps or compensated fluorescent tubes, which can be seen in FIG. 2 of the descriptive report; one of the connections corresponds to linking the ballast to the capacitor, the same that shall be connected to a circuit breaker end, being the other breaker end connected to a terminal known as hot conductor or the power supply line (L); other connections refers to another ballast end, the same that shall be connected to one lamp or fluorescent tube filament; the third connection refers to the other capacitor end and shall be connected to terminal or neutral conductor of power supply, and to another lamp filament; finally, is connected the starter or trigger between the remaining lamp filaments.

2. “MAGNETIC BALLAST” as described in claim 1, wherein it comprises under the same fairing, case or base with covering, a ballast or magnetic reactance and a compensating capacitor all connected electrically in series.

3. “MAGNETIC BALLAST” as described in claim 1, wherein said compensating ballast shall have available, by means of binding points, cables or other connection mechanism, without limitation, three electrical connections that shall be interconnected correctly to remaining elements necessary to the implementation of a lighting circuit with lamps or compensated fluorescent tubes, which can be seen in FIG. 2 of the descriptive report.

4. “MAGNETIC BALLAST” as described in claim 2, wherein one of the connections corresponds to the linking between ballast and capacitor, said linking should be connected to a circuit breaker end, being the other breaker end connected to a terminal known as hot conductor or line (L) from power supply.

5. “MAGNETIC BALLAST” as described in claim 3, wherein other connections is related to the other ballast end, which should be connected to one lamp filament or fluorescent tube; finally, the third connection refers to the other capacitor end and should be connected to power supply terminal or neutral conductor and to other lamp filaments; finally, it connects to starter between the remaining lamp filaments.
